(19) United States
(12) Patent Application Publication
(10) Pub. No.: US 2026/0300610 A1
(43) Pub. Date: Oct. 1, 2026

(54) INFORMATION CONVERSION DEVICE AND INFORMATION CONVERSION METHOD USING A LARGE-SCALE LANGUAGE MODEL

(71) Applicant: NEC Corporation, Tokyo (JP)

(72) Inventors: Tatsuya FUKUDA, Tokyo (JP); Masaharu MORIMOTO, Tokyo (JP); Yoshiaki SAKAE, Tokyo (JP); Joe BRINTON, Tokyo (JP); Ryosuke HOTCHI, Tokyo (JP); Masaki INOKUCHI, Tokyo (JP); Sian En OOI, Tokyo (JP); Shunsuke OSAKI, Tokyo (JP)

(73) Assignee: NEC Corporation, Tokyo (JP)

(21) Appl. No.: 19/576,303

(22) Filed: Mar. 24, 2026

(30) Foreign Application Priority Data
Mar. 28, 2025 (JP) 2025-055893

(51) Int. Cl. G06F 40/111

(52) U.S. Cl. CPC G06F 40/111

(57) ABSTRACT

For generating a new document from multiple related documents, etc., using an LLM, to acquire accurate output from the LLM, the information conversion device includes a receiving unit which accepts data for inputting to an LLM, a data notation conversion unit which acquires data notation of the expected LLM output, and inputs the data to the LLM for converting the data notation into generic data notation, and an output unit which outputs data whose data notation has been converted.

This application is based upon and claims the benefit of priority from the Japanese Patent Application No. 2025-055893 filed on Mar. 28, 2025, the entire disclosure of which is hereby incorporated.

### BACKGROUND OF THE INVENTION

### Technical Field

The present disclosure relates to an information conversion device and an information conversion method using a large-scale language model.

### Background Art

Large language model (LLM) is a machine learning model whose core is natural language processing. LLMs are learning models trained using large amounts of text data. Generally, to handle a desired task, the parameters of an LLM are fine-tuned by training it on a specific dataset (for example, see Patent Document 1).

### CITATION LIST

### Patent Literature

[Patent literature 1] Japanese Patent Application Publication No. 2024-43563

### SUMMARY OF THE INVENTION

There may be a need to generate a new document from multiple related documents, etc. To address such a need, utilizing an LLM is considered.

One example is a task of creating a new design document from an existing system design document or a similar design document and the corresponding program source code. Such a task may arise, for instance, when a system design has become outdated and needs to be updated to the latest design. Note that the content of the new design document is semantically equivalent to that of the existing design document.

Hereinafter, the existing design document may be referred to as a legacy design document or a legacy document. The existing source code may be referred to as a legacy source code or a legacy code. The new design document may be referred to as a modern design document or a modern document.

When using an LLM to create a modern design document based on the legacy design document and a legacy source code, that is, when converting the legacy design document and the legacy source code into a modern design document, achieving an accurate conversion can be difficult.

For example, if there are discrepancies or inconsistencies between the meaning of the legacy design document and the meaning of the legacy source code, the legacy design document and the legacy source code cannot be treated as a unified whole. Further, if there are areas where the correspondence between the content of the legacy design document and the content of the legacy source code is unclear, achieving an accurate conversion to a modern design document is difficult.

Therefore, when using legacy design documents and legacy source code as input for an LLM, manual comparison and review of the LLM's output results with the legacy design documents and the legacy source code is required.

The object of the present disclosure is to provide an information conversion device and an information conversion method that enables acquiring accurate output from an LLM when generating a new document, etc., from multiple related documents, etc., using an LLM.

The information conversion device based on present disclosure includes receiving means for accepting data for inputting to an LLM, data notation conversion means for acquiring data notation of the expected LLM output, inputting the data to the LLM for converting the data notation into generic (general-purpose) data notation, and output means for outputting data whose data notation has been converted.

The information conversion method based on present disclosure is a method executed by a computer, accepting data for inputting to an LLM, acquiring data notation of the expected LLM output, and inputting the data to the LLM for converting the data notation into generic data notation, and outputting data whose data notation has been converted.

The information conversion program based on present disclosure causes a computer to execute accepting data for inputting to an LLM, acquiring data notation of the expected LLM output, inputting the data to the LLM for converting the data notation into generic data notation, and outputting data whose data notation has been converted.

According to the present disclosure, the accuracy of the LLM's output results can be improved.

### BRIEF DESCRIPTION OF THE DRAWINGS

FIG. 1 It depicts an explanatory diagram showing the concept of the information conversion device using an LLM.

FIG. 2 It depicts a block diagram showing an example of hardware configuration of the information conversion device.

FIG. 3 It depicts a block diagram showing an example of the functional blocks of the information conversion device.

FIG. 4 It depicts a flowchart showing an example of the operation of the information conversion device.

FIG. 5 It depicts a block diagram showing another example of the functional blocks of the information conversion device.

FIG. 6 It depicts a flowchart showing another example of the operation of the information conversion device.

FIG. 7 It depicts a block diagram showing yet another example of the functional blocks of the information conversion device.

FIG. 8 It depicts a flowchart showing still another example of the operation of the information conversion device.

FIG. 9 It depicts a block diagram showing still another example of the functional blocks of the information conversion device.

FIG. 10 It depicts a flowchart showing another example of the operation of the information conversion device.

FIG. 11 It depicts a block diagram showing the main part of the information conversion device.

### DESCRIPTION OF THE EXAMPLE EMBODIMENTS

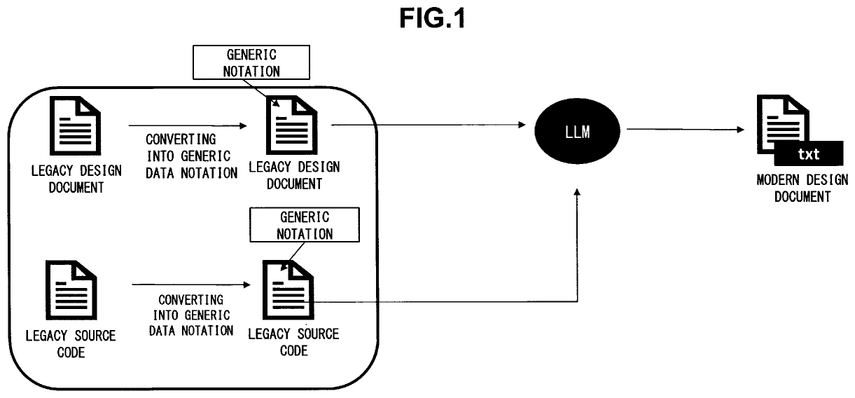

First, the concept of the present disclosure is explained. FIG. 1 is an explanatory diagram showing the concept of the information conversion device using an LLM. An example is provided where a modern design document is created based on a legacy design document and a legacy source code.

The information conversion device based on present disclosure converts at least the data notation of the legacy design document and the legacy source code into generic data notation. Note that “data notation” can be rephrased as the manner of data representation or the data structure. The legacy design document and the legacy source code in the data notation output by the information conversion device are input to the LLM. The generic data notation is, for example, not data notation specialized for a particular purpose, and is notation that can be easily understood and reused by many designers and others involved in system design.

In the example embodiments described below, the information conversion device handles legacy design documents and legacy source code. However, the types of documents handled by the information conversion device are not limited to these. The information conversion device in the following example embodiments can be applied to generate a new document from multiple types of documents that are relevant, other than legacy design documents and legacy source code. Furthermore, the number of documents may be three or more.

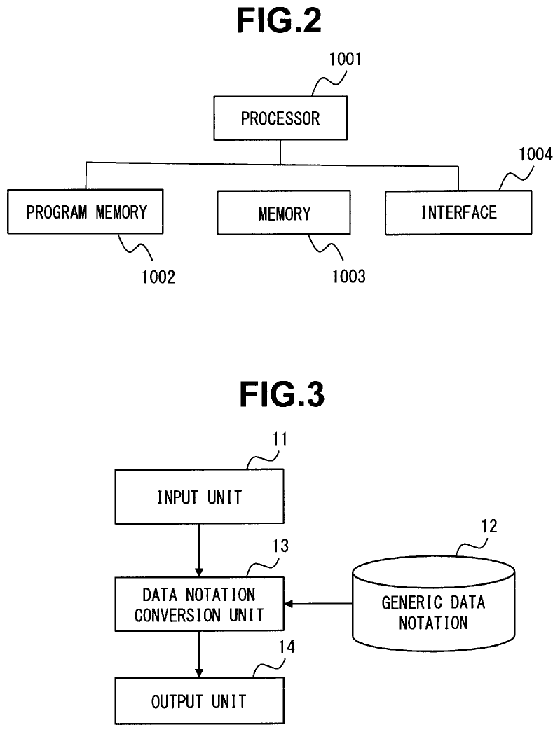

FIG. 2 is a block diagram showing an example of the hardware configuration of the information conversion device. The information conversion device can be implemented using an information processing device as illustrated in FIG. 2. The information processing device is, for example, a server device or a personal computer.

The information processing device illustrated in FIG. 2 includes one or more processors 1001, such as a CPU (Central Processing Unit), a program memory 1002, a memory 1003, and an interface 1004. FIG. 2 illustrates an example of an information processing device having one processor 1001.

The program memory 1002 is, for example, a non-transitory computer-readable medium. The non-transitory computer-readable medium includes various types of tangible storage media. For example, a semiconductor storage medium such as flash ROM (Read Only Memory) or a magnetic storage medium such as a hard disk can be used as the program memory 1002. The program memory 1002 stores an information conversion program that implements the functions of the information conversion device in each example embodiment described below.

The processor 1001 implements the functions of each block (excluding the storage) in the information conversion device by executing processing according to the information conversion program stored in the program memory 1002. When multiple processors are installed, multiple processors may cooperate to implement the functions of the information conversion device.

The memory 1003 may, for example, utilize RAM (Random Access Memory). The memory 1003 stores temporary data generated while the information conversion device is executing processing. It is also conceivable that an information conversion program is transferred to the memory 1003, and the processor 1001 executes processing based on the information conversion program in the memory 1003. Note that the program memory 1002 and the memory 1003 may be integrated.

Further, the semiconductor storage medium such as a flash ROM (Read Only Memory) or a magnetic storage medium such as a hard disk can be used as the memory 1003. The memory 1003 using these can realize the database in the information conversion device of each example embodiment described below.

The interface 1004 is an input/output unit for inputting data such as documents or outputting processing results, either directly or through a communication line.

Hereinafter, an example embodiment of the present disclosure will be explained with reference to the drawings.

### Example Embodiment 1

FIG. 3 is a block diagram showing an example of functional blocks of an information conversion device. The information conversion device shown in FIG. 3 comprises an input unit 11, a generic data notation storage 12, a data notation conversion unit 13, and an output unit 14.

The information conversion device may be implemented, for example, by hardware such as that shown in FIG. 2. In that case, the input unit 11, the data notation conversion unit 13, and the output unit 14 are implemented by the processor 1001 that executes processing according to a program and the interface 1004.

The input unit 11 inputs data such as design documents and source code (in this example embodiment and the following example embodiments, legacy design documents and legacy source code). The generic data notation storage 12 is a database storing multiple types of generic data notation (the preferred generic data notation after conversion, i.e., the data notation expected for the LLM's output).

The data notation conversion unit 13 changes the data notation of the design document and the source code to one of the generic data notation stored in the generic data notation storage 12. The output unit 14 outputs the design document and source code with their data notation changed.

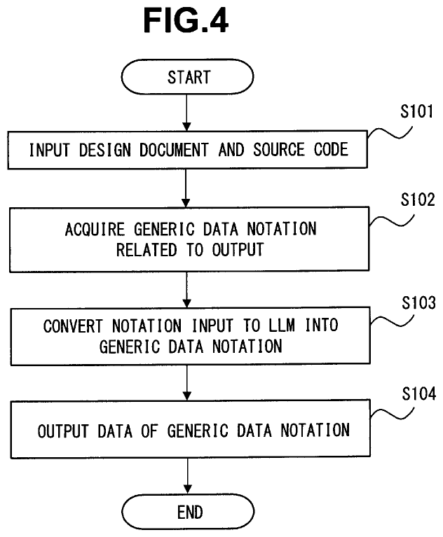

Next, the operation of the information conversion device of this example embodiment will be explained with reference to FIG. 4. FIG. 4 is a flowchart showing an example of the operation of the information conversion device of this example embodiment.

The input unit 11 receives input of a design document and source code (step S101). The data notation conversion unit 13 acquires generic data notation suitable for the design document and the source code input to the input unit 11, i.e., the design document and the source code to be handled, from generic data notation storage 12 (step S102).

Then, the data notation conversion unit 13 inputs the data to the LLM, which converts both the design document notation and the source code data notation into generic data notation (step S103). The output unit 14 outputs the data of the design document and the source code whose data notation have been converted (step S104).

It should be noted that the data notation conversion unit 13 may utilize existing conversion tools (conversion software) for the data notation acquired from the generic data notation storage 12, if available, to convert the data notation of the design document and the source code.

In addition, an example of generic data notation is data notation (data structure) utilizing the Model View Controller (MVC) architecture.

In this example embodiment, the data notation conversion unit 13 converts the data notation of both the design document and the source code into a single generic data notation. Therefore, when the design document and the source code are input into the LLM, it is expected that data comparison and combination within the LLM will become easier. As a result, it becomes possible to acquire a high-accuracy modern design document (a modern design document containing meaning closer to that of the legacy design document) using the LLM.

Further, conversion accuracy (from the legacy design document to the modern design document) is also improved by standardizing the data notation of legacy design document and the legacy source code with that of the modern design document.

### Example Embodiment 2

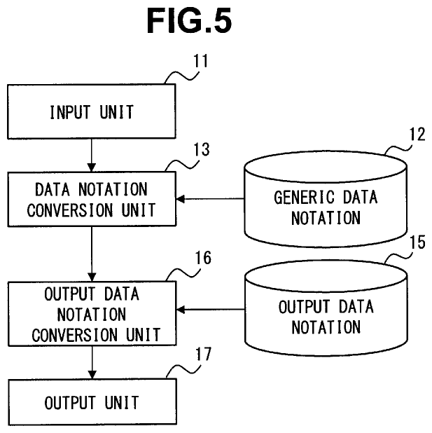

FIG. 5 is a block diagram showing another example of the functional blocks of the information conversion device. The information conversion device shown in FIG. 5 comprises an input unit 11, a generic data notation storage 12, a data notation conversion unit 13, an output data notation storage 15, an output data notation conversion unit 16, and an output unit 17. The input unit 11, the generic data notation storage 12, and the data notation conversion unit 13 have the same functions as those in the first example embodiment.

The information conversion device can be implemented, for example, in hardware as shown in FIG. 2. In that case, the input unit 11, the data notation conversion unit 13, the output data notation conversion unit 16, and the output unit 17 are implemented by the processor 1001 that executes processing according to a program and the interface 1004.

The output data notation storage 15 is a database storing multiple types of output data notation (data notation for the target modern design documents). The output data notation is the data notation for the modern design documents that the LLM should output. The output data notation conversion unit 16 converts the generic data notation produced by the data notation conversion unit 13 into one of the output data notation stored in the output data notation storage 15. The output unit 17 outputs the design document and the source code with the changed data notation, along with the output data notation.

As an example, the generic data notation is a data structure (data notation) utilizing MVC architecture, and the output data notation is a structured text format.

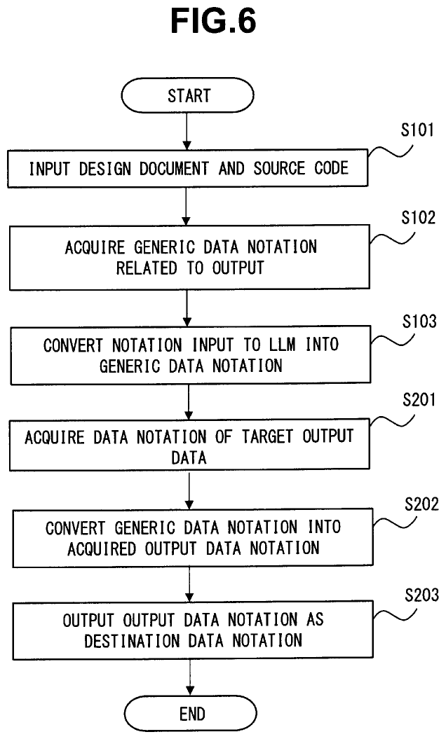

Next, the operation of the information conversion device of this example embodiment is explained with reference to FIG. 6. FIG. 6 is a flowchart showing an example of the operation of the information conversion device of this example embodiment.

The processing in steps S101 to S103 is the same as the processing in the first example embodiment shown in FIG. 4.

The output data notation conversion unit 16 acquires the data notation (output data notation) of the target output data (in this example embodiment, the modern design document) from the output data notation storage 15 (step S201). The output data notation conversion unit 16 further converts the data notation converted by the data notation conversion unit 13 into the output data notation acquired from the output data notation storage 15 (step S202). The conversion method is the same as that used by the data notation conversion unit 13.

The output unit 17 also outputs the output data notation converted from the generic data notation (step S203).

In this example embodiment, since the output data notation conversion unit 16 acquires the desired output data notation based on generic data notation related to the input data, the conversion accuracy (from legacy design document to the modern design document) is higher.

### Example Embodiment 3

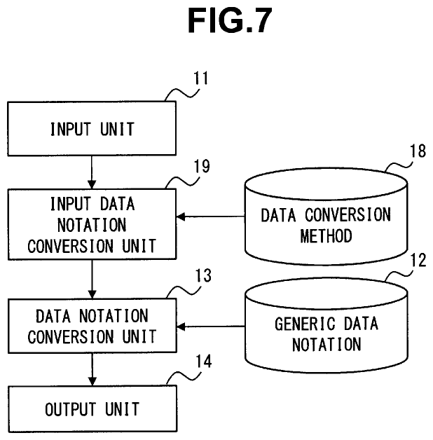

FIG. 7 is a block diagram showing yet another example of the functional blocks of the information conversion device. The information conversion device shown in FIG. 7 comprises an input unit 11, a data conversion method storage 18, an input data notation conversion unit 19, a generic data notation storage 12, a data notation conversion unit 13, and an output unit 14. The input unit 11, the generic data notation storage 12, the data notation conversion unit 13, and the output unit 14 have the same functions as those in the first example embodiment.

The information conversion device can be implemented, for example, using hardware as shown in FIG. 2. In that case, the input unit 11, the input data notation conversion unit 19, the data notation conversion unit 13, and the output unit 14 are implemented by the processor 1001 that executes processing according to a program and the interface 1004.

Design documents and source code may contain images and diagrams in addition to text data. When such a design document or source code are input to an LLM to acquire a modern design document, only the text data was typically extracted and input to the LLM. However, such processing has issues, such as being unable to handle images or causing the meaning of table structures to be lost.

In this example embodiment, text data, images, diagrams, etc., within a design document and source code are converted into data of data notation appropriate for each. Examples of appropriate data notation include a structured text format and a Base64.

The data conversion method storage 18 stores multiple conversion methods for each format (for example, text, image, diagram). The conversion methods correspond to generic data notation. The input data notation conversion unit 19 acquires conversion methods corresponding to the format of the data contained in the design document and the source code from the data conversion method storage 18. Then, the input data notation conversion unit 19 converts the data notation of the design document and source code according to the acquired conversion method.

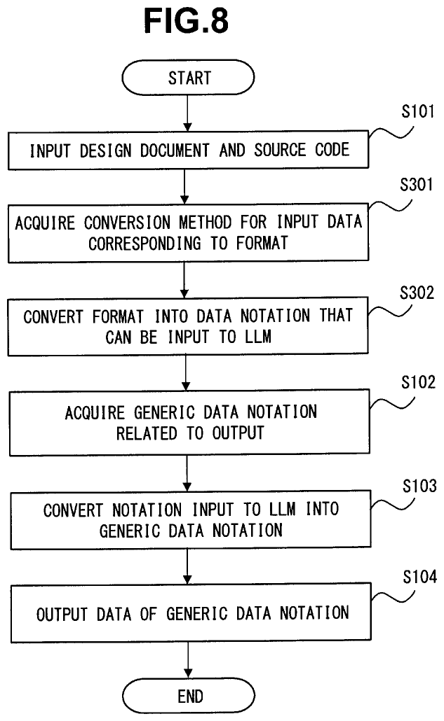

Next, the operation of the information conversion device of this example embodiment will be explained with reference to FIG. 8. FIG. 8 is a flowchart showing an example of the operation of the information conversion device of this example embodiment.

The processing in steps S101 to S104 is the same as the processing in the first example embodiment shown in FIG. 4.

In this example embodiment, when a design document and source code are input, the input data notation conversion unit 19 selects a conversion method corresponding to the design document and the source code (step S301). The input data notation conversion unit 19 converts the data notation of the design document and the source code into data notation based on the conversion method acquired from the data conversion method storage 18. In other words, the input data notation conversion unit 19 converts the notation of the design document and source code into data notation that can be input to the LLM (step S302). Subsequently, the processing of steps S102 to S104 is executed. Data notation that can be input to the LLM means data notation that is easy for the LLM to process.

In this example embodiment, in addition to the effect of the first example embodiment, the following effect can be acquired.

Specifically, since the data notation of the design document and source code data are converted into data notation suitable for the notation of the design document and the source code, enabling LLM processing while preserving the meaning contained within the design document and the source code.

### Example Embodiment 4

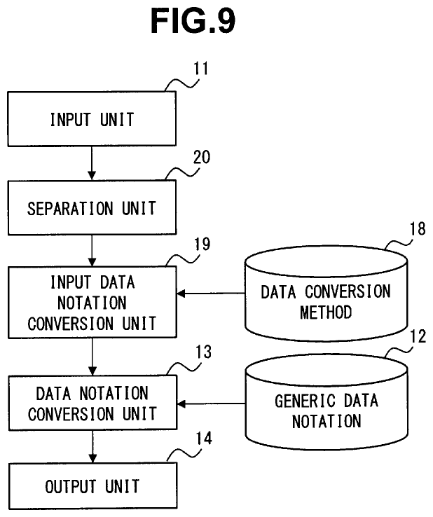

FIG. 9 is a block diagram showing still another example of the functional blocks of the information conversion device. The information conversion device shown in FIG. 9 comprises an input unit 11, a separation unit 20, a data conversion method storage 18, an input data notation conversion unit 19, a generic data notation storage 12, a data notation conversion unit 13, and an output unit 14. The input unit 11, the data conversion method storage 18, the input data notation conversion unit 19, the generic data notation storage 12, the data notation conversion unit 13, and the output unit 14 have the same functions as those in the third example embodiment.

The information conversion device can be implemented, for example, by hardware as shown in FIG. 2. In that case, the input unit 11, the separation unit 20, the input data notation conversion unit 19, the data notation conversion unit 13, and the output unit 14 are implemented by the processor 1001 that executes processing according to a program and the interface 1004.

The input data notation conversion unit 19 converts the data notation for each of the multiple formats contained within the input data (data from the design document or the source code).

The separation unit 20 separates the contents of the input data by format. For example, the separation unit 20 separates the input data into text portions, image portions, and diagram portions.

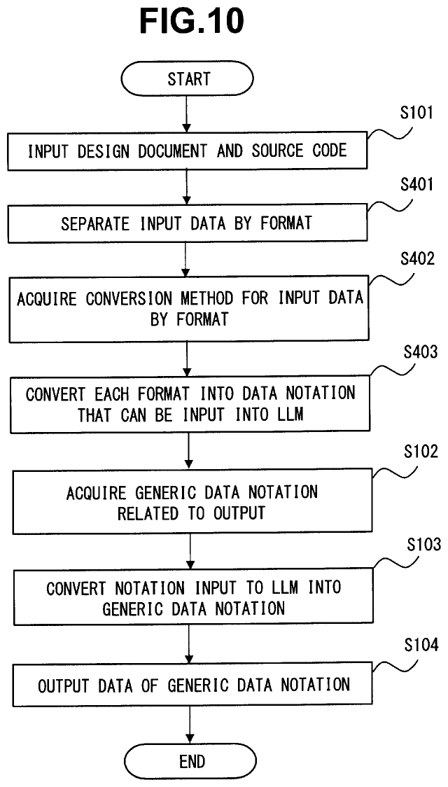

Next, the operation of the information conversion device of this example embodiment will be explained with reference to FIG. 10. FIG. 10 is a flowchart showing an example of the operation of the information conversion device of this example embodiment.

The processing in steps S101 to S104 is the same as the processing in the first example embodiment shown in FIG. 4.

In this example embodiment, when a design document and source code are input, the separation unit 20 separates the input data by format (step S401). The input data notation conversion unit 19 selects a conversion method corresponding to each separated data (step S402). The input data notation conversion unit 19 converts the data notation of the design document and the source code, for each format, into data notation based on the conversion method acquired from the data conversion method storage 18. In other words, the input data notation conversion unit 19 converts the format of the design document and the source code into data notation that can be input to the LLM (easily processed by the LLM) (step S403). Subsequently, the processing of steps S102 to S104 is executed.

In this example embodiment, in addition to the effects of the first and third example embodiments, the following effect can be acquired.

That is, even when text data, images, diagrams, etc., are mixed within a design document or source code, since the data notation of the input data is converted into data notation suitable for the formats of the design document and the source code for each format, enabling LLM processing while preserving the meaning contained within the design document and the source code.

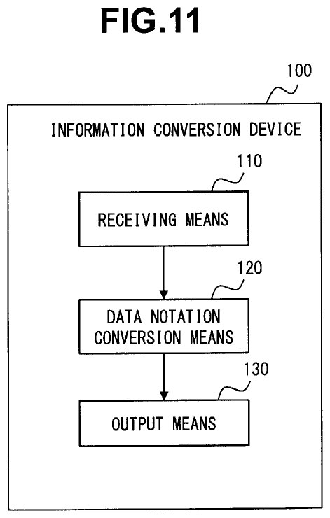

FIG. 11 is a block diagram showing the main part of the information conversion device. The information conversion device 100 shown in FIG. 11 comprises receiving means 110 (realized by the input unit 11 in the example embodiments) for accepting data for inputting to an LLM, data notation conversion means 120 (realized by the generic data notation storage 12 in the example embodiments) for acquiring data notation of the expected LLM output, inputting the data to the LLM for converting the data notation into generic data notation, and output means 130 (realized by the output unit 14 in the example embodiments) for outputting data whose data notation has been converted.

The present disclosure has been described with reference to example embodiments, but the disclosure is not limited to the above example embodiments. Various modifications may be made to the configuration and operation of the disclosure within the scope of the disclosure that would be understood by those skilled in the art. Furthermore, each example embodiment may be combined with other example embodiments as appropriate.

A part of or all of the above example embodiment may also be described as, but not limited to, the following Supplementary notes.

(Supplementary note 1) An information conversion device, comprising:
receiving means for accepting data for inputting to an LLM,
data notation conversion means for acquiring data notation of the expected LLM output, and inputting the data to the LLM for converting the data notation into generic data notation, and output means for outputting data whose data notation has been converted.

(Supplementary note 2) The information conversion device according to Supplementary note 1, comprising output data notation conversion means for converting the data notation converted into the generic data notation into a desired output data notation from the LLM, wherein
the output means outputs the desired output data notation.

(Supplementary note 3) The information conversion device according to Supplementary note 1, comprising input data notation conversion means for converting the data notation of data input to the LLM into data notation corresponding to the format of the data input to the LLM, wherein
the data notation conversion means further converts the data notation, that has been converted into the data notation corresponding to the format of the data input to the LLM, into the generic data notation.

(Supplementary note 4) The information conversion device according to Supplementary note 3, comprising separate means for separating data input to the LLM for each format, wherein
the input data notation conversion means converts the data notation of data input to the LLM into data notation corresponding to the form of separated data, by format.

(Supplementary note 5) An information conversion method, implemented by a processor, comprising:
accepting data for inputting to an LLM,
acquiring data notation of the expected LLM output, and inputting the data to the LLM for converting the data notation into generic data notation, and
outputting data whose data notation has been converted.

(Supplementary note 6) An information conversion program causing a computer to execute:
accepting data for inputting to an LLM,
acquiring data notation of the expected LLM output, and inputting the data to the LLM for converting the data notation into generic data notation, and
outputting data whose data notation has been converted.

Some or all of the configurations described in Supplementary notes 2 and 3, which are dependent on Supplementary note 1 described above, can be dependent on Supplementary notes 5 and 6 by the same dependency relationship as Supplementary note 1. Further, Some or all of the configurations described in Supplementary note 4, which is dependent on Supplementary note 3, can be dependent on Supplementary notes 5 and 6 by the same indirectly dependency relationship as Supplementary note 1. Moreover, not limited to Supplementary notes 5 and 6, some or all of the configurations described as Supplementary notes can similarly depend on various hardware, software, various recording means for recording software, or systems, on condition that the above example embodiment are not deviated from.

What is claimed is:

1. An information conversion device, comprising:
a memory storing software instructions; and
one or more processors configured to execute the software instructions to:
accept data for inputting to an LLM,
acquire data notation of the expected LLM output, and input the data to the LLM for converting the data notation into generic data notation, and
output data whose data notation has been converted.

2. The information conversion device according to claim 1,
wherein the one or more processors are configured to execute the software instructions to convert the data notation converted into the generic data notation into a desired output data notation from the LLM, and
output the desired output data notation.

3. The information conversion device according to claim 1,
wherein the one or more processors are configured to execute the software instructions to convert the data notation of data input to the LLM into data notation corresponding to the format of the data input to the LLM, and
further convert the data notation, that has been converted into the data notation corresponding to the format of the data input to the LLM, into the generic data notation.

4. The information conversion device according to claim 3,
wherein the one or more processors are configured to execute the software instructions to separate data input to the LLM for each format,
convert the data notation of data input to the LLM into data notation corresponding to the format of separated data, by format.

5. An information conversion method, implemented by a processor, comprising:
accepting data for inputting to an LLM,
acquiring data notation of the expected LLM output, and inputting the data to the LLM for converting the data notation into generic data notation, and
outputting data whose data notation has been converted.

6. The information conversion method, implemented by a processor, according to claim 5,
converting the data notation converted into the generic data notation into a desired output data notation from the LLM, and
outputting the desired output data notation.

7. The information conversion method, implemented by a processor, according to claim 5,
converting the data notation of data input to the LLM into data notation corresponding to the format of the data input to the LLM, and
further converting the data notation, that has been converted into the data notation corresponding to the format of the data input to the LLM, into the generic data notation.

8. The information conversion method, implemented by a processor, according to claim 7,
separating data input to the LLM for each format,
converting the data notation of data input to the LLM into data notation corresponding to the format of separated data, by format.

9. A non-transitory computer-readable recording medium storing an information conversion program, wherein
the information conversion program causes a computer to execute:
accepting data for inputting to an LLM,
acquiring data notation of the expected LLM output, and inputting the data to the LLM for converting the data notation into generic data notation, and
outputting data whose data notation has been converted.
